(19) United States
(12) Patent Application Publication
(10) Pub. No.: US 2003/0147099 A1
(43) Pub. Date: Aug. 7, 2003

(54) Annotation of electronically-transmitted images

(76) Inventors: Larry M. Heimendinger, Studio City, CA (US); Richard J. McConnell, Sherman Oaks, CA (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/072,180

(22) Filed: Feb. 7, 2002

(51) Int. Cl. H04N 1/40

(52) U.S. Cl. 358/462

(57) ABSTRACT

A system for annotating image data prompts a user to annotate image data and transmits the annotation to a recipient according to predefined preferences to facilitate simultaneous review of the image data and the annotation by the recipient.

### FIELD OF THE INVENTION

The present invention relates to the fields of communications and electronic imaging.

### BACKGROUND OF THE INVENTION

In the modern environment, image data is nearly universally available. It is commonly generated by a variety of standard equipment and communicated according to many different formats and protocols. Image data itself is the inherent product of most business activities and often its creation is the ultimate goal of such activities. Photographs and video capture images of optically perceptible phenomena at different points in time. Art and animation provide representations of visual expression to convey information. Paper documents and electronic documents include text and graphics to communicate information. Each of these may be represented as image data, e.g., analog or digital information signals representing images that may be optically displayed. Converted into electrical signals, image data may be stored, transmitted and displayed by conventional technologies.

The apparatus for creating image data are commonplace. For example, conventional facsimile machines, photocopiers, digital scanners, film recorders, transparency adaptors, and x-ray digitizers are devices that create image data representing printed materials. Typically, such devices scan a printed item to create representative image data and process that data to achieve specific results. Digital cameras and video recorders create image data representing images obtained through an optical lens. In these and other conventional ways, significant quantities of information are routinely transformed into image data.

Digital image data is of particular importance due to its robust nature, the ease with which it is stored and the feasibility of its transmission through communications networks. Public and private telephone systems, packet-switched data networks (e.g., LAN, WAN and the Internet), and digital data channels (e.g., ISDN lines, microwave communication systems, and satellite communication systems), routinely carry vast quantities of image data around the world to the great benefit of many and serve as the foundation for much economic activity and personal communications. However, in many cases, such image data travels alone.

While particular image data may serve as a self-sufficient message, in certain instances, it will be necessary to add information to the image data or otherwise annotate it. Frequently, commentary, explanation, emphasis and other important information relating to image data must be communicated in order to complete a message that includes image data. For example, a radiologist may desire to highlight a particular region on an X-ray image that is being electronically forwarded to a colleague for analysis; an engineer may need to describe details of a design only partly illustrated on a drawing; or a lawyer may need to explain revisions made to a document distributed by facsimile to a group of recipients. In each of these examples, the need for image data annotation is clearly evident.

Even in the context of ordinary interpersonal interactions, the annotation of image data could be quite helpful. For example, although a relative may appreciate receiving image data and viewing a display of the corresponding image, the prior art fails to provide the functionality for a coordinated presentation of audio information. The further potential comfort achievable by viewing displayed image data and listening to coordinated audio commentary from a familiar voice is not made available in the prior art.

In the prior art, images are only annotated manually through cumbersome and inefficient procedures. In the case of facsimile transmissions and photocopiers, annotation is accomplished by actually modifying the image data, i.e., manually writing on the document, or by creating and appending additional image data to the document, i.e., creating and appending a cover page. With certain scanners, digitizers, cameras, and video recorders, annotating text can be manually typed into the device and incorporated into image data stored as a data file by the particular device. Each of the foregoing is merely the implementation of a manual procedure for annotating image data with additional information.

Obviously, such manual procedures suffer many disadvantages. The manual modification of image data to include annotation information is inherently unsuitable in certain circumstances as it necessitates that the original image data be altered and be transmitted as altered. Moreover, it is both complicated and time-consuming to manually modify image data or to manually create additional image data each time annotation is required. The modification of an existing image, or the creation of an additional image, involves the consumption of valuable resources, such as paper, ink, and storage space which, at least in the aggregate, may be quite expensive. In addition, the generation of image data corresponding to an additional image requires a further imaging operation of the particular imaging device, resulting in increased costs and the expenditure of inordinate amounts of time. Of course, the transmission of additional image data appended, or otherwise added by modification, to the original image data increases the length of the transmission and utilizes communications bandwidth, resulting in increased costs.

Further, the utilization of resources in manually annotating image data is typically very inefficient. In a typical facsimile transmission, relatively little information is included in a facsimile cover sheet as compared to the document it accompanies. Nevertheless, the cover sheet often exists as an additional printed page that must be created, imaged, transmitted, and stored at some expense. Obviously, such underutilization of paper is quite wasteful. The expense attributable to the cover page alone increases significantly when the time and operational costs of using the sender's and the receiver's facsimile devices to transmit and receive a cover page are considered as well. A less costly, more efficient and environmentally-responsible manner of communicating the information contained on a facsimile cover sheet is needed.

Also known in the prior art are e-mail communication systems having the capability to allow a user to attach separate media files to a particular e-mail message and transmit the message with incorporated media files as a single transmission to a particular recipient. While such media files may include audio data and video data, the creation and manual concatenation of such files is a cumbersome process and does not constitute the annotation of any specific portion of image data. Even the inclusion of text in an e-mail message that refers to the content of attached files of image data does not constitute the annotation of any specific portion of such data. At most, the process of placing annotation information in a file and concatenating that file with a file of image data in an e-mail message is merely a manual annotation process.

Similarly, the fairly common procedure of sending a facsimile transmission and then calling the intended recipient to leave a voicemail message regarding the facsimile transmission is merely another cumbersome manual process for providing annotation information regarding transmitted image data. Of course, it is also common to send an e-mail message containing image data and then call the intended recipient to discuss the contents of the message. Such manual processes of making a “follow-up call” after image data is transmitted illustrates a most compelling problem: the prior art provides no reliable coordination among (1) the transmission of image data to a recipient, (2) the creation and transmission of annotation information, and (3) the association by the recipient of the annotation information with the transmitted image data.

Further, in the prior art, the recipient of image data often has no reliable notice that annotation information corresponding to transmitted image data has or has not been transmitted. Where annotation information, or a reference thereto, is not directly incorporated into transmitted image data, the recipient of image data will not know that the sender even intended to provide annotation information. Even if the intention to communicate annotation information is expressed to the recipient of image data, the prior art provides no confirmation to the recipient of image data that annotation information corresponding to that data was actually transmitted by the sender and is available for access. Instead, in the prior art, the recipient of image data must manually search to locate annotation information and analyze such information to determine whether it corresponds to transmitted image data. Consequently, transmitted annotation information may never be considered by a recipient of transmitted image data, or otherwise may be received too late to be usable by the recipient.

Importantly, none of the existing technologies provide an automated system for annotating image data and separately transmitting image data and annotation information to an intended recipient.

### SUMMARY OF THE INVENTION

The present invention represents a significant advance over the prior art in that it provides an integrated electronic system for communicating annotation information along with image data. Advantageously, the present invention provides an intuitive and efficient system for capturing annotation information and associating such information with image data. Annotation information may be captured as audio or video, registered with specific image data or portions thereof, and transmitted separately from the image data to a receiving party. The image data and annotation information are made available to the receiving party in a coordinated manner for contemporaneous use.

According to a preferred embodiment, while image data is being displayed by a recipient, corresponding annotation information may be accessed for use in real time. Thus, the communication of annotation information according to the present invention is more convenient and more economical than manual annotation processes in the prior art. In addition, by facilitating the annotation of images or selected portions thereof, both the sending and receiving parties may rapidly associate annotation information with specific image data to reap significant time and cost savings.

By capturing a sending party's own articulation of annotation information as audio or video specifically associating that annotation with transmitted image data, the present invention facilitates faster more efficient and more complete communication of important information. Unlike written annotation, the utilization of annotating audio or video information conveniently conveys nuisances and subtleties not appropriate for inclusion in the image data itself. By using different modes of communication, information that cannot be effectively conveyed as image data, or as a modification to image data, may nevertheless be communicated as annotation information. In certain applications, implementation of the present invention to communicate annotation information will provide significant time and cost savings to both the sending and receiving parties as compared to manual annotation processes.

As a further advantage, in certain embodiments, the transmission of annotation information according to the present invention implements communications security functionality. Annotation information can serve to confirm the authenticity of transmitted image data or communicate a security key.

Accordingly, it is an object of the invention to further overcome the problems and deficiencies of the prior art.

In particular, it is an object of the invention to provide methods, apparatus and systems for automating the annotation of image data.

It is another object of the invention to provide improved methods, apparatus and systems for annotating electronically-transmitted image data.

It is a further object of the invention to provide apparatus and methodology for capturing annotation information and associating such information with a particular transmission of image data or a portion thereof.

It is also an object of the invention to provide apparatus and methodology for the coordinated transmission of image data and annotation information via different communication paths.

It is still another object of the invention to provide apparatus and methodology for notifying the recipient of transmitted image data that associated annotation information is available.

It is yet another object of the invention to provide apparatus and methodology for the coordinated presentation of image data and annotation information.

According to an aspect of the invention, an annotation processing apparatus includes an image data interface, an annotation interface, and a processor. The processor is coupled to the image data interface and the annotation interface. The processor detects transmissions of image data presented at the image data interface and controls the annotation interface to prompt a user to supply an annotation.

According to another aspect of the invention a method of annotating image data includes the steps of receiving a transmission of image data to a recipient; receiving from an annotation source an annotation corresponding to the image data; and transmitting the annotation to the recipient.

According to another aspect of the invention a method of annotating image data includes the steps of receiving a transmission of image data to a recipient; receiving from an annotation source an annotation corresponding to the image data; displaying the annotation to a user; receiving from the user a second annotation; and transmitting the second annotation to the recipient for the image data.

According to a further aspect of the invention a method of annotating image data includes the steps of receiving a transmission of image data to a recipient; displaying the image data to a user; receiving a selection of a portion of image data from the user; receiving from an annotation source an annotation corresponding to the portion selected; and transmitting the annotation to the recipient.

According to yet another aspect of the invention an image data and annotation communication system includes an image and annotation processing system and a communications network coupled to the image and annotation processing system.

### BRIEF DESCRIPTION OF THE DRAWINGS

FIG. 1 is a block diagram of a processing system according to an embodiment of the present invention;

FIG. 2 is a flow diagram of a method of operation according to an embodiment of the present invention;

FIG. 3 is a block diagram of a processing system according to an embodiment of the present invention;

FIG. 4 is a flow diagram of another method of operation according to an embodiment of the present invention;

FIG. 5 is an illustration of sample image data to which reference is made in describing a method of operation according to an embodiment of the present invention;

FIG. 6 is a block diagram of a communications system according to an embodiment of the present invention;

FIGS. 7A-7E are block diagrams of processing systems according to embodiments of the present invention;

FIG. 8 is a flow diagram of another method of operation according to an embodiment of the present invention; and

FIG. 9 is a flow diagram of a further method of operation according to an embodiment of the present invention.

### DETAILED DESCRIPTION OF THE INVENTION

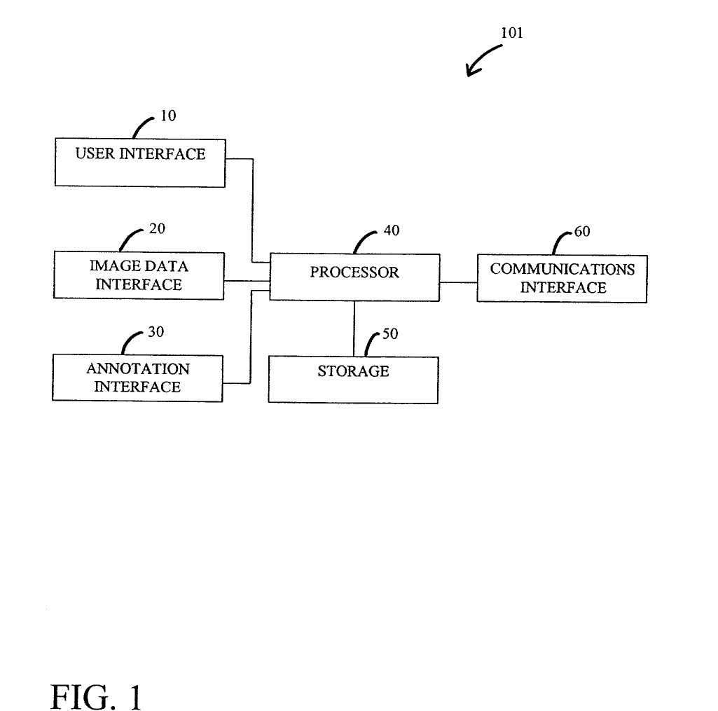

In FIG. 1, an image and annotation processing system 101 according to an embodiment of the present invention is shown. As shown, image and annotation processing system 101 comprises user interface 10, image data interface 20, annotation interface 30, processor 40, storage 50 and communications interface 60. Processor 40 is coupled to each of user interface 10, image data interface 20, annotation interface 30, storage 50 and communications interface 60.

Preferably, the entire annotation processing system 101 is fabricated on a single printed circuit board and its components are interconnected by printed circuit wires, ordinary wires, or the like. Alternatively, system 101 may be fabricated as individual component parts interconnected by conventional coupling technology such as, but not limited to, wireless communications, optical communications, e.g., fiber-optics, infra-red communications, and the like. As a further alternative, system 101 may be implemented as a computer program or software routine which is adapted to run on a microprocessor-based computer system, for example, a personal computer equipped with an Intel Pentium 4 processor or the like.

User interface 10 is an interface for system 101 through which a user may monitor the operation of system 101 and, in certain embodiments, control the operation of system 101. In a preferred embodiment, user interface 10 includes a user-perceptible indication that a transmission of image data is pending. Interface 10 preferably also includes a user input device for receiving user input to control the operation of system 101. The user input device may comprise a keypad or array of buttons (not shown) for the entry of user commands. Alternatively, interface 10 may include a graphical display for displaying information regarding the operation of system 101 to a user and a pointing device, such as a mouse, a touch screen, or the like, for receiving user commands. As a further alternative, interface 10 may include an audio interface, such as a speaker and a microphone, for audibly prompting a user to control system 101 and for receiving commands from the user.

Image data interface 20 is a conventional interface for connecting system 101 to one or more conventional image data sources, such as those described hereinabove. Preferably, data interface 20 comprises a series of hardware ports with supporting electronics for receiving image data at high speeds. For example, image data interface 20 may comprise a “fire wire” IEEE-1394 input port for receiving video signals, an RJ-11 telephone port for receiving modem signals, an Ethernet connection port for receiving high-speed digital signals, an S-video port for receiving high-speed video signal transmissions, a component video signal port array for receiving two or more component video signals, a Universal Serial Bus (USB) port, a High Speed Serial Data Connector (HSSDC) port, a fiber optics connector, a radio-frequency wireless communications port, or the like. Image data interface 20 may optionally include hardware or a software-controlled microprocessor-based system or the like for formatting or otherwise changing the protocol of image data input to interface 20.

In a preferred embodiment, image data interface 20 emulates a communications network so that an image data source will transmit image data directly to interface 20. For example, in one embodiment interface 20 generates dial tones and facsimile machine tones to interact with a facsimile machine that is dialing and negotiating to send a facsimile. In an alternate embodiment, image data interface, in conjunction with processor 40, control the operation of image data sources, e.g., a scanner, camera, or the like, to obtain image data.

Annotation interface 30 comprises an interface through which annotation information is received. In connection with the present invention, “annotation” information refers to any information, regardless of form, that a sender designates to correspond or otherwise relate to particular image data. In a preferred embodiment, annotation interface 30 comprises a microphone for receiving verbal dictation from a user and a loudspeaker for audibly reproducing the recorded dictation for review by the user. For example, interface 30 may comprise a telephone handset, a computer microphone and speaker assembly, a dictation device, a personal voice recorder, or the like through which a user may provide or record audio annotation information.

In another embodiment, annotation interface 30 comprises a video interface for receiving user annotation in the form of video signals. For example, interface 30 may comprise a video phone, a personal computer with a camera device, or the like, through which a user may provide or record video or audio/video annotation information.

Alternatively, annotation interface 30 may comprise a communications port for receiving annotation information from a conventional source. For example, interface 30 may comprise any of the interfaces or other apparatus identified in the description of user interface 10 or image data interface 20. Optionally, interface 30 may include hardware, or a software-controlled microprocessor system for formatting or otherwise changing the protocol of input annotation information.

User interface 10 and annotation interface 30 may be integrated into a single device and may comprise the same components. For example, both user interface 10 and annotation interface 30 may be implemented as a cellular telephone, as a personal digital assistant, in software for a software-controlled computer system, or the like. Importantly, in an alternate embodiment, annotation interface 30 may be configured to receive data representing recorded annotation information. Such recorded information may be provided by conventional recording devices, such as audio or video tape recorders, or accessed directly from (portable) semiconductor memory, high density magnetic or optical recording media, or the like.

Processor 40 is the primary processing system of system 101 for controlling the operation of system 101, or the flow of data among any of its constituent components. Preferably, processor 40 comprises a software-controlled microprocessor-based system, a microcontroller or a personal computer equipped with an Intel Pentium 4 processor, a controlled array of data switches, or the like. Preferably, processor 40 receives user input via user interface 10, image data via image data interface 20, and annotation information via annotation interface 30. Processor 40 may route image data or annotation information to storage 50 for temporary storage or to communications interface 60 for output. For example, processor 40 may route image data from image data interface 20 to storage 50 for temporary storage and control user interface 10 to poll a user for annotation information. Processor 40 may control annotation interface 30 to receive annotation information. Such information may be routed by processor 40 from annotation interface 30 to storage 50 for temporary storage, for buffering, or the like. Additionally, processor 40 may detect data communications and control system 101 to buffer and transmit input data. Further, processor 40 log communications of image data and annotation information and store logs of the operation of system 101 in storage 50 for later retrieval and output.

In an alternative embodiment, processor 40 detects input image data and annotation information, processes the image data and annotation information to prepare each for transmission and controls the transmission of each to a communications network.

In a further alternate embodiment, processor 40 controls system 101 to receive image data or annotation information and process same for playback or display to a user. Details regarding such functionality of processor 40 will be provided hereinbelow in connection with the discussion of additional figures.

Storage 50 comprises a storage device for storing data, such as image data and annotation information. Preferably, storage 50 comprises a semiconductor memory, a hard disk drive, a tape storage device, a writable compact disk, a writable DVD, a writable video disk, a floppy disk, or the like. The operation of storage 50 may be controlled by processor 40. Alternatively, processor 40 controls the flow of information to and from storage 50.

Communications interface 60 is a conventional communications interface for coupling to conventional communications networks. In a preferred embodiment, communications interface 60 comprises a communications port, such as any of those described in connection with image data interface 20, a wireless communications interface, an optical communications interface, an infrared communications interface, or the like. Preferably, the operation of interface 60 is controlled by processor 40. Optionally, interface 60 includes hardware or a software-controlled microprocessor-based system for formatting or otherwise changing the protocol of data forwarded from processor 40 for transmission. In an alternate embodiment, communications interface 60 is coupled directly to one or more of image data interface 20, annotation interface 30, and storage 50.

In a preferred operation of image and annotation processing system 101, system 101 operates to acquire annotation information from a user, associate that information with image data, process both the image data and the annotation information, and transmit both to a particular recipient. Preferably, system 101 is configured as a functional addition to a conventional image data transmission apparatus. Alternatively, implemented in software, the functionality of system 101 may be integrated into existing processes for transmitting image data as a processing step that occurs prior to transmission of image data.

As a further alternative, system 101 may store information regarding the annotation transmission preferences of selected image data recipients to enable a consistent customized transmission of annotation information to a particular recipient.

Further, image and annotation processing system 101 may be configured to receive transmitted image data and transmitted annotation information and facilitate display of both to a recipient. As a receiving unit, system 101 may be preprogrammed with annotation transmission preferences of a particular image data recipient. In accordance with those preferences, system 101 may process the annotation information and route it to a recipient according to the recipient's preferred communications procedure.

In a preferred method of operation according to an embodiment of the invention, the annotation of a facsimile transmission occurs in a multi-step process. The user inserts a document into a facsimile machine, provides a telephone number and a code to be recognized by system 101 as indicating that an annotation is needed. The user presses the send button on the facsimile machine, and it goes off hook, dials the telephone number and the code. System 101 recognizes the off hook state of the facsimile machine and supplies a dial tone to the facsimile machine. System 101 stores the telephone number it receives and decodes the annotation code. After recognizing the annotation code, system 101 audibly prompts the user to provide an annotation through a speaker included in system 101 or through the handset of the facsimile machine. The user may record an annotation live by audio, audio/video or video or provide a pre-recorded annotation.

Additional modes of operation of system 101 will be described in further detail hereinbelow in connection with additional Figures presented herein.

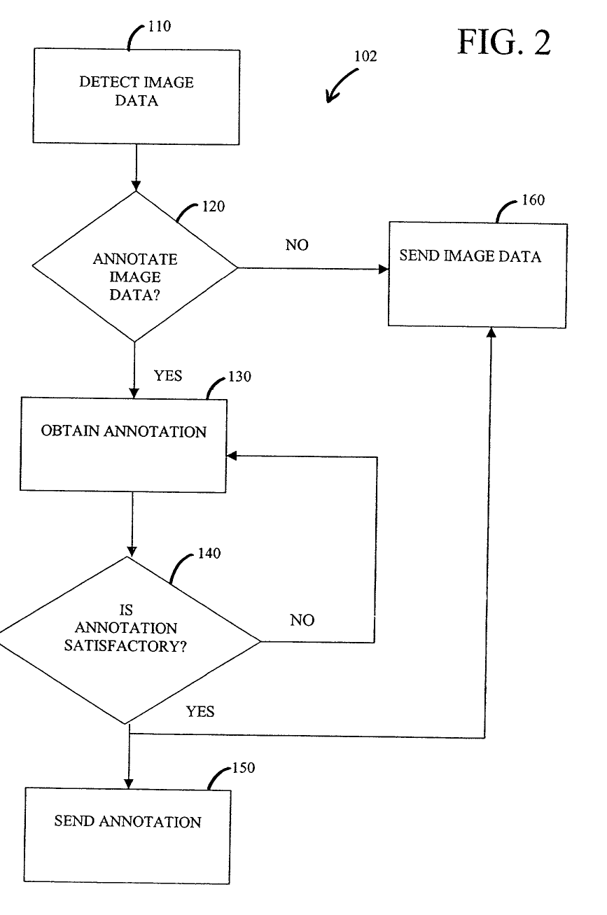

FIG. 2 presents a flow chart of a preferred method of operation 102 according to an embodiment of the present invention. Method of operation 102 may be implemented on annotation processing system 101, in other apparatus, or as functionality implemented in software for a software-controlled computer system. In a first step 110, image data that has been generated or queued for transmission is detected. The data itself may be detected or communications information for routing the data, e.g., a telephone number, a network address, an email address, or the like, may be detected. Preferably, step 110 is implemented by image data interface 20 alone or as controlled by processor 40.

Alternatively, step 110 may comprise the step of receiving an indication from a user that image data has been selected for annotation, e.g., a special code is provided by the user in the image data or in the destination information. For example, the user may type a special code into a facsimile machine that is recognized as a selection of image data for annotation. As a further alternative, in step 110 a signal that image data is ready for annotation may be received from an image data source, such as an image data storage device, a communications network, or the like. Optionally, step 110 may be omitted. Processing proceeds to step 120.

In step 120, the user is polled to determine whether annotation of the image data is desired. If the user indicates that annotation of the image data is desired, processing proceeds with step 130; otherwise, processing proceeds with step 160. Preferably, step 120 is implemented by user interface 10 alone or as controlled by processor 40. The user is signaled that a transmission of image data is pending, e.g., by a flashing light on user interface 10. The user enters a command on user interface 10, e.g., presses a button, to indicate whether annotation of the image data is desired. As a further alternative, step 120 may require that all image data be annotated, removing the opportunity for the user to send image data without annotation. Annotation may be required to provide security functionality, to ensure that annotation information is conveyed or to provide records of the transmissions of image data. Accordingly, in such an alternative embodiment, processing would proceed only with step 130. Alternatively, in step 120, prior to polling the user, the image data is displayed to the user for review.

In step 130, annotation information is obtained from an annotation source. As previously described hereinabove, suitable annotation sources may include, but are not limited to, audio or video input directly from a user, recorded annotation information, or the like. Preferably, step 130 is implemented by annotation interface 30 alone or as controlled by processor 40. After step 130, processing proceeds with step 140.

In step 140, the user is polled to determine whether the annotation information obtained is satisfactory to the user. Preferably, the annotation information is reproduced for review by the user. If the user indicates that the annotation information is satisfactory, processing proceeds with step 150 and step 160; otherwise, processing proceeds with step 130. Preferably, step 140 is implemented by user interface 10 alone or as controlled by processor 40. Alternatively, step 140 is implemented by interface 10 and interface 30, both controlled by processor 40. In an alternate embodiment, step 140 is omitted from method of operation 102 and processing after step 130 proceeds with step 150 and step 160.

According to step 150, the obtained annotation information is transmitted to the recipient. Preferably, processor 40 routes annotation information from interface 30 to communications interface 60 and through interface 60 accesses a communications network to transmit the annotation information to the recipient. The communications routing information for the transmission of annotation information may be provided by the user via user interface 10 or, if pre-stored, obtained from storage 50.

According to step 160, the image data is also transmitted to the recipient. Preferably, processor 40 routes image data from interface 20 to communications interface 60 and through interface 60 accesses a communications network to transmit the image data to the recipient. The communications routing information for the transmission of image data may be provided by the user via user interface 10 or, if pre-stored, obtained from storage 50. In an alternative embodiment, where processor 40 detects communications routing information to detect image data, processor 40 stores the communications routing information in storage 50 for later retrieval.

In another alternative embodiment of step 160, user interface 10 is also controlled by processor 40 to prompt a user for destination information, e.g., a telephone, email address, network address, or the like, for the image data to be transmitted.

In yet another embodiment of step 160, if step 140 was a prior operational step, then the mage data is modified to include an indication that an annotation will be transmitted as well. The indication is preferably a symbol of annotation, e.g., an icon, indicating the specific location in the image data relevant to the annotation. Alternatively, the indication may be an entire set of instructions for the recipient regarding the proper method for accessing the annotation information. Sample instructions include the provision of a telephone number or website address and a code with instructions that the recipient dial the number or access the website, enter the code and access an audio message stored on a audio messaging system, e.g., a voice mail system. Alternatively, the instructions could be sent as an email to the recipient, indicate the existence of the annotation and the process for retrieving the annotation.

In a further alternative embodiment, steps 120 and steps 140 are omitted and processing after step 110 proceeds with step 130 while processing after step 130 proceeds with steps 150 and 160.

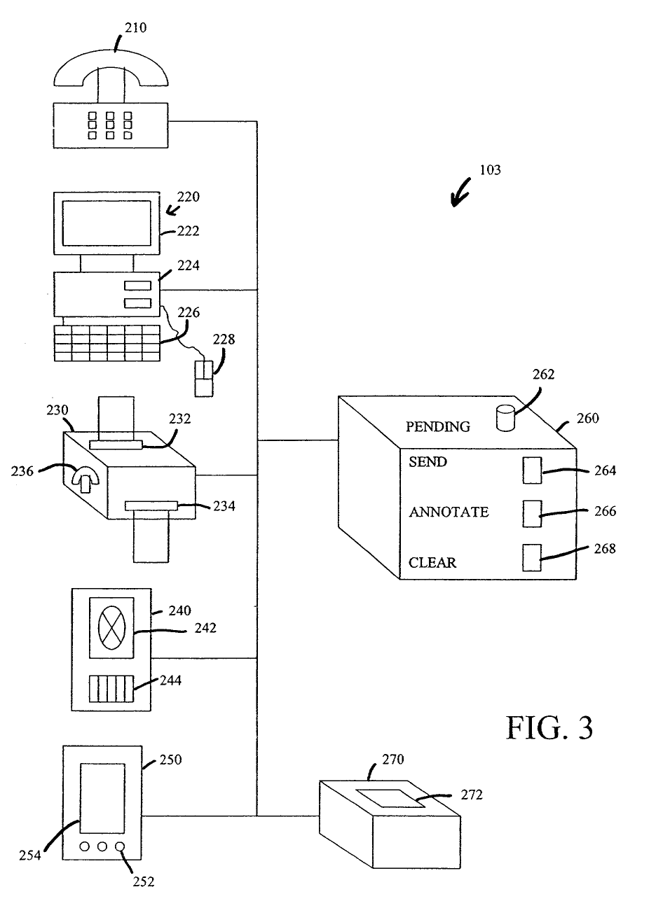

FIG. 3 illustrates an annotation system according to an embodiment of the present invention. As shown, system 103 comprises telephone 210, computer 220, facsimile machine 230, audio device 240, personal communications device 250, device 260, and scanning device 270. As shown, each of telephone 210, computer 220, facsimile machine 230, audio device 240, personal communications device 250, device 260, and scanning device 270 are coupled to device 260. Telephone 210 is a conventional telephone communication device such as a touch-tone telephone, a video phone, a wireless telephone, a cellular telephone, or the like. Computer 220 is a conventional computer such as an Intel Pentium 4-based personal computer comprising a display 222, a processing system 224, a keyboard 226, and a pointing device 228. Each of the components of computer 220 are conventional and may be substituted with conventional equivalents. Computer 220 may also include a microphone and speaker (not shown) to receive audio input from a user and play back audio signals; Computer 220 may be a portable computer or palm top.

Facsimile machine 230 is a conventional facsimile machine for scanning an image of a document inserted into document input port 232 which, after the scanning operation is complete, is output through document output port 234. Preferably, facsimile machine 230 includes a telephone handset 236 through which a user may communicate.

Audio device 240 is a conventional audio device that includes a speaker 242 and a microphone 244 in a single apparatus. Examples of such conventional audio devices include voice recorders, cassette recorders, dictation machines, and the like. Alternatively, audio device 240 may comprise separate microphone and speaker components. Optionally, audio device 240 may be incorporated into another conventional item of office equipment, e.g., a photocopier, a printer, a scanner, or the like.

Device 250 is a personal communications device such as a cellular telephone, conventional beeper, pager, cellular telephone, wireless personal digital assistant (PDA), or the like. As shown, communications device 250 includes a user input 252 (e.g., a button, pointing device, track ball, or the like) and a display 254 (e.g., a LED or LCD display). Optionally, device 250 may include a graphical interface and a pointing device for displaying image data and selecting portions of image date for annotation.

Device 260, in a preferred embodiment, is an entire annotation system corresponding to system 101. Alternatively, device 260 is only a subset of system 101, for example, a user interface 10. In a preferred embodiment, device 260 includes a user interface 10 that includes a transmission pending display indicator 262, a send button 264, an annotate button 266, and a clear button 268. Preferably, pending display indicator 262 is a lamp or LED that illuminates, a bell that rings, or the like to indicate that a transmission of image data is pending. Alternatively, pending display indicator 262 provides an indication that image data that was transmitted or stored was detected. Buttons 264, 266, and 268 are conventional push buttons. Alternatively, buttons 264, 266, and 268 may be implemented as conventional switches, knobs, levers, keypad keys, or the like.

In a further alternative, pending display indicator 262 and buttons 264, 266, and 268 are integrated in an interface device, e.g., a torch screen graphical user interface, a display screen with a pointing device in a computer system, a multifunction dial, or the like.

Device 270 is a conventional scanning device for creating image data. Device 270 may be, for example, a document scanner, a photocopier, a digitizer, an x-ray scanner, a camera, or the like. Preferably, device 270 includes a scanning surface 272.

The coupling between device 260 and the other devices of system 103 may be by any conventional coupling technology, such as network cable, wireless communications, optical communications, and the like.

In a preferred embodiment, device 260 detects the creation, attempted transmission, or transmission of image data by computer 220, facsimile machine 230, personal communications device 250, or scanning device 270. Upon detection of the image data or the attempted transmission or transmission of same, device 260 causes pending indicator 262 to signal to a user that image data is pending annotation. According to a basic operation, a user selects among the three commands send, annotate, and clear to control the operation of device 260. If the user desires to allow the image data to be transmitted, than the send button 264 is activated and device 260 transmits the image data it has stored, signals another device to transmit the image data or, if the image data was already transmitted, does nothing with respect to the image data. If the user does not want the transmission of image data to occur, than the clear button 268 is activated. If the user desires to annotate the image data, then the annotation button 266 is activated and the user provides or selects annotation information to correspond to the image data that is received by device 260. For example, the annotation information may be provided by the user by speaking into the handset 236 of facsimile machine 230. Preferably, after one of the buttons 264, 266, and 268 is activated, display indicator 262 changes to reflect the user input.

In another preferred embodiment, annotation information may be provided by a user by speaking into, or capturing a video image with, telephone 210, computer 220 (equipped with a microphone or camera, not shown), or personal communications device 250. Alternatively, annotation information may be provided by a user by speaking into microphone 244 of audio device 240.

In an alternate embodiment, device 260 is incorporated into one or more of telephone 210, computer 220, facsimile machine 230, audio device 240, personal communications device 250, and scanning device 270.

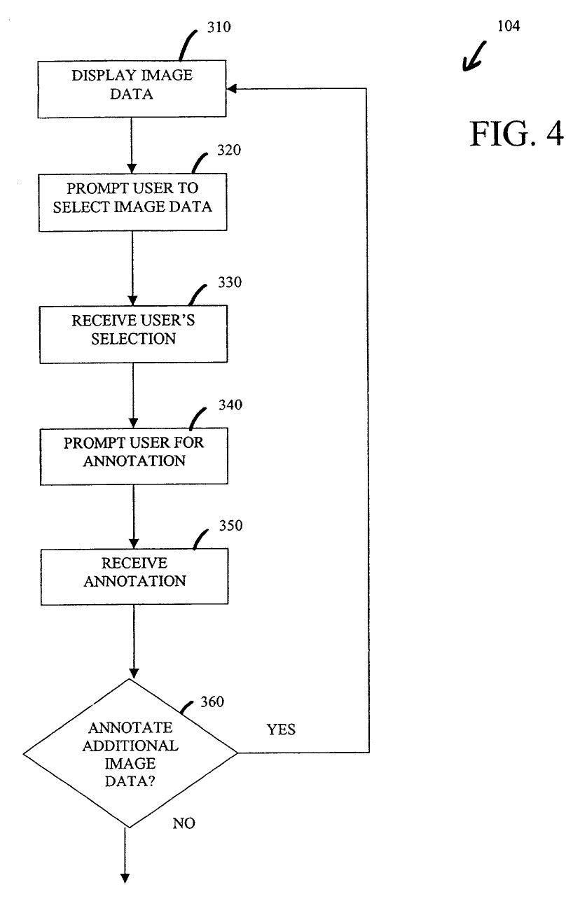

FIG. 4 illustrates a flow diagram of a process 104 of preferred operation according to the present invention. To facilitate explanation, process 104 will be discussed in connection with a preferred implementation in system 101. In a first step 310, image data is displayed to a user, preferably by a user interface 10. In the next step 320, the user is prompted to select image data, either from among a collection of image data displayed, or a portion of a particular set of image data, again preferably via user interface 10. Processing proceeds with step 330 in which the user's selection of particular image data is recognized preferably by processor 40 and, optionally, stored in storage 50. In the next step 340, the user is prompted for annotation information, preferably either at user interface 10 or annotation interface 30. Processing proceeds with step 350 and the annotation information provided by the user via annotation interface 30 is recognized, preferably by processor 40 and, optionally, stored in storage 50. Following step 350, processing may proceed with step 360, in which the user is queried, preferably at user interface 10, whether the annotation of additional image data is desired. If the annotation of additional image data is desired, processing returns to step 310; otherwise, processing according to process 104 is ended. Optionally, step 360 may be omitted from process 104.

In an alternate embodiment, process 104 proceeds as described above; however, step 350 is modified in that the annotation information is not stored or otherwise recorded and is routed for transmission, preferably by processor 40 from annotation interface 30 to communications interface 60.

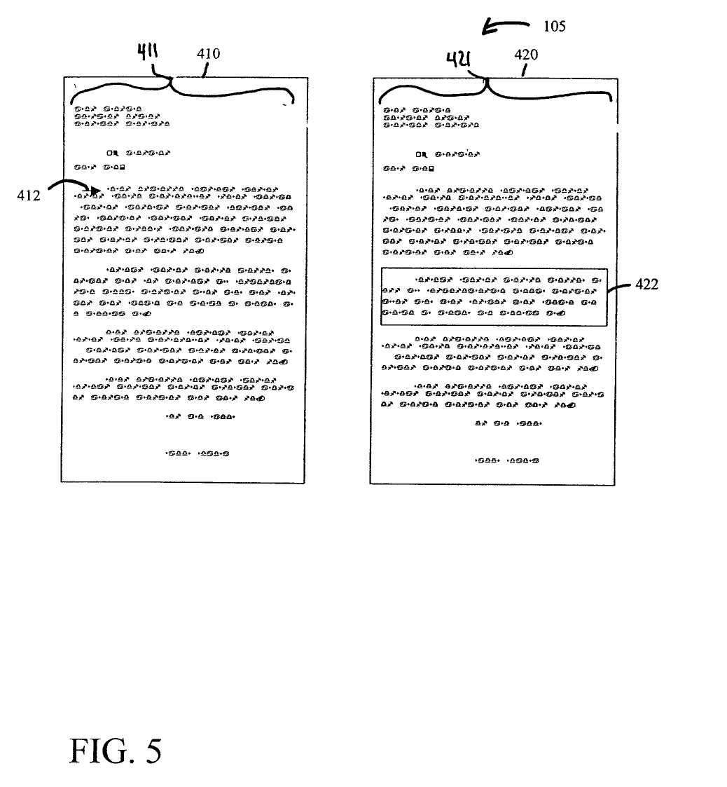

FIG. 5 illustrates a pair of sample displays 105 of image data on a user interface for the viewing and selection of particular image data for annotation by a user. Such displays may occur on display screen 222 of computer 220 or display screen 254 of personal communications device 250, for example. For purpose of illustration, image data 411 and 421 are shown displayed in displays 410 and 420, respectively, each as a multi-paragraph letter.

In display 410, a pointer 412, e.g., an arrow, cube, or the like, is also shown. Arrow 412 is controlled in a conventional manner by a pointing device to select particular locations in a display of image data or portions of text. For example, pointing device 228 may be used to select portions of the displayed image data. Implemented in communications device 250, pointer 412 may be controlled with input device 252 or, if display 254 is touch-sensitive, by touching display screen 254 itself. As shown in display 410, pointer 412 is pointing to the beginning of the first paragraph of text. Preferably, a mark or other indication which may or may not be visible is inserted into the image data at the position selected by the user. As shown in display 420, the second full paragraph of text has been specifically selected, as indicated by selection box 422.

In an alternate embodiment, image data generated by or stored in another device is routed to a graphical user interface (GUI) by device 260 to facilitate annotation of image data by a user.

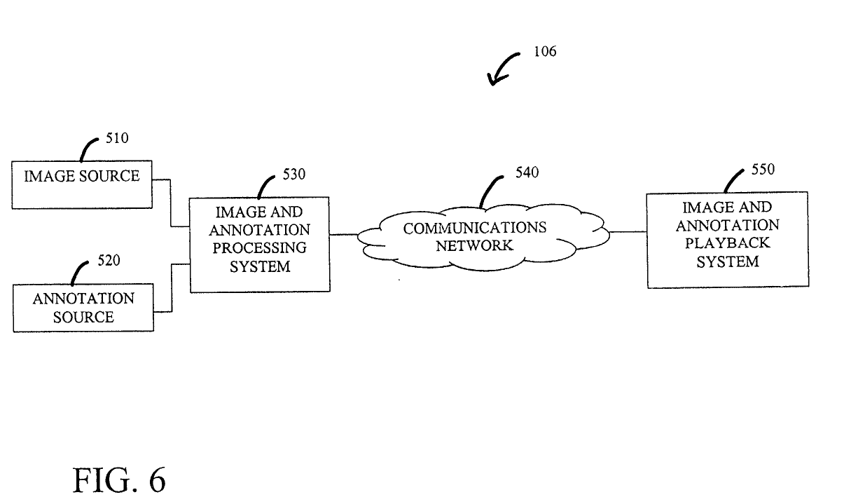

FIG. 6 shows a block diagram of a communications system 106 according to another embodiment of the present invention. System 106 comprises an image source 510, an annotation source 520, an image and annotation processing system 530, a communications network 540, and an image and annotation playback system 550. As shown, image source 510 and annotation source 520 are coupled to image and annotation processing system 530. System 530 and system 550 are each coupled to communications network 540. Image source 510 is a conventional source of image data as hereinbefore described. Annotation source 520 is a source of annotation information as described previously, for example, a telephone 210, personal communications device 250, etc. Image and annotation processing system 530 is preferably an image and annotation processing apparatus 101 according to the present invention. Communications network 540 is a conventional communications network, such as a local area network (LAN), a wide area network (WAN), a public telephone system, the internet, a wireless communications network, or the like. Image and annotation playback system 550 is preferably an image and annotation processing apparatus 101. Alternatively, playback system 550 is comprised of conventional equipment for displaying image data and annotation information (audio, video, or both).

In operation, the user controls image and annotation processing system 530 to receive image data from image source 510 and annotation information from annotation source 520. To facilitate economical transmissions, processing system 530 may store image data or annotation information for a period of time. In a preferred embodiment, system 530 emulates network 540 so that it may intercept a transmission of image source 510. System 530 sends the image data and annotation information to playback system 550 via communications network 540. The image data and the annotation information may travel in the same or in different forms, along the same or different communications paths, and in the same or different protocols. For example, the image data may be transmitted according to a Type III facsimile protocol through an ordinary telephone communications system while the annotation is transmitted as a pager text message via a satellite paging transmission system. The image data and annotation information are received at playback system 540 and displayed to the user simultaneously or at different times.

In an alternate embodiment, image and annotation playback system 550 is operable to confirm receipt of image data or annotation information. Playback system 550 may also confirm that the image data or annotation information has been accessed (by a user). Such confirmation may be sent by returning a transmission to system 530 or to another communications device accessible to the sender. System 550 may read image data, annotation information, or other information transmitted by processing system 530 to identify an address of the sender, or otherwise accessible to the sender, to which a confirmation message can be sent.

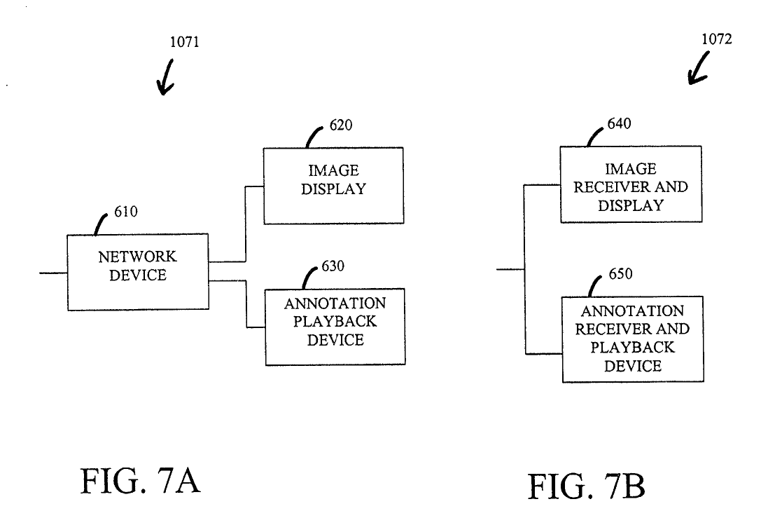

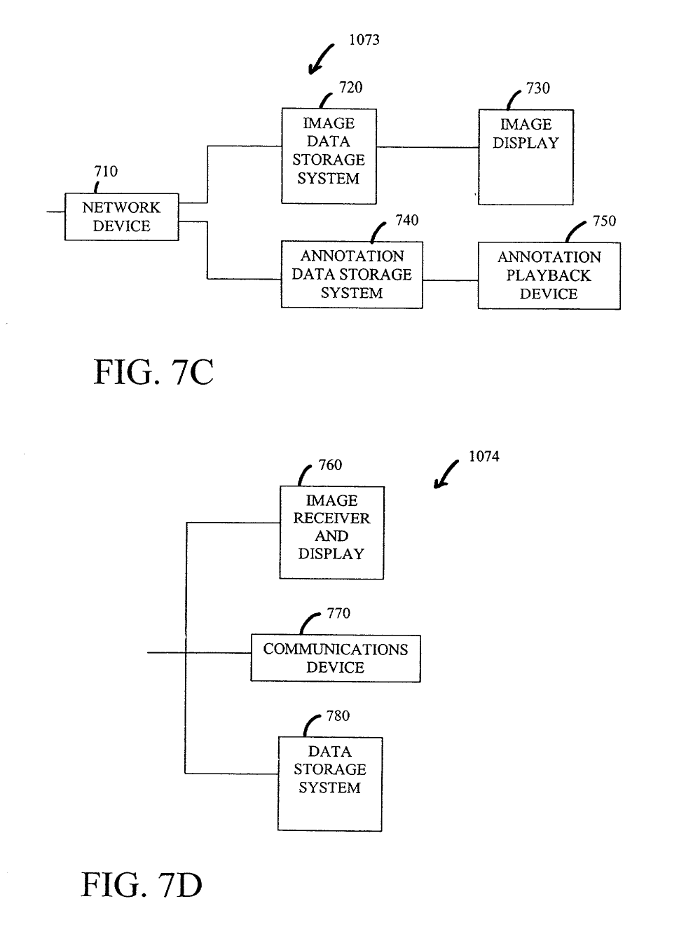

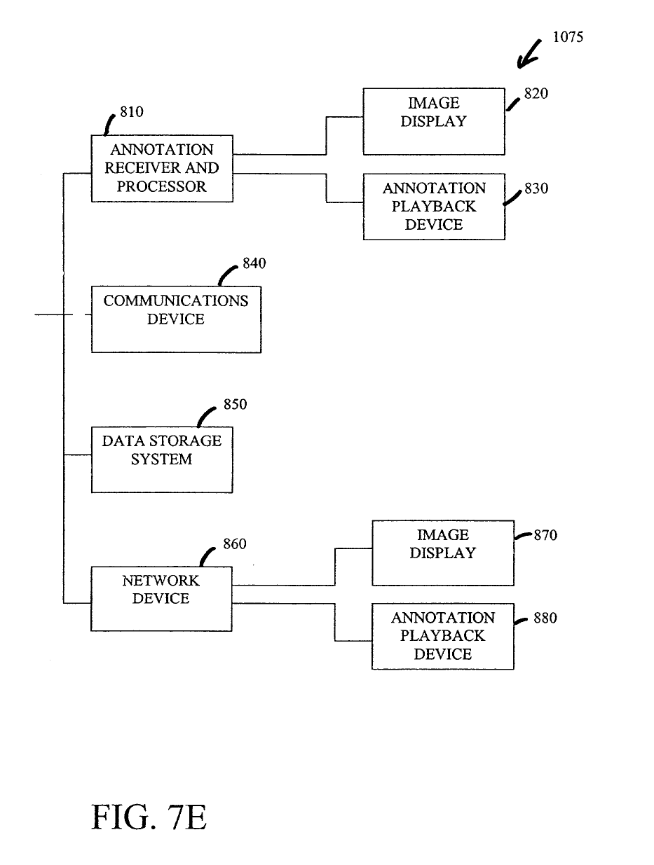

Alternate embodiments of image and annotation playback system 550 are shown in FIGS. 7A, 7B, 7C, 7D and 7E. In FIG. 7A, system 1071 is shown. System 1071 includes a network device 610, an image display 620, and an annotation playback device 630. As shown, network device 610 is coupled to each of image display 620 and annotation playback device 630.

Network device 610 is a conventional network device for interfacing with a communications network. Preferably, device 610 is configured to route image data signals to a display, e.g., image display 620, and route annotation information to a playback device, e.g., annotation playback device 630. Of course, network device 610 may be a component of a larger apparatus or be implemented as a software routine in a software-controlled microprocessor system. For example, device 610 may be telephone 210, computer 220, facsimile machine 230, audio device 240, personal communications device 250, or input device 260.

Image display 620 is a conventional display device, e.g., screen, printer, facsimile machine, or the like, for displaying image data, and annotation playback device 630 is a conventional playback device for reproducing audio signals or video signals for a user, e.g., a speaker, a display, a device with both, or the like. Preferably system 1071 is implemented in a personal computer PDA, facsimile machine or the like.

FIG. 7B illustrates an image and annotation playback system 1072 comprising an image receiver and display 640 and an annotation receiver and playback device 650. Image receiver and display 640 is a conventional device for receiving image data and displaying it. Device 640 may be independently addressable or simply a terminal for displaying image data transmitted through a network. Annotation receiver and playback device 650 is an apparatus for receiving annotation information via a communications network and reproducing the annotation information for a user. Device 650 may be independently addressable or simply a terminal for the reproduction of annotation information for a user. Preferably, display 640 is a personal computer, PDA, or the like, and device 650 is a voice messaging system. Preferably, display 640 is implemented in a personal computer, PDA, facsimile machine or the like and device 650 is implemented in a voice messaging system.

FIG. 7C is a block diagram of an image and annotation playback system 1073. System 1073 comprises network device 710, image data storage system 720, image display 730, annotation data storage system 740 and annotation playback device 750. Network device 710 is the same as network device 610. Image display 730 is the same as image display 620. Annotation playback device 750 is the same as annotation playback device 630. As shown, network device 710 is coupled to image data storage system 720 and annotation data storage system 740. System 720 is also coupled to image display 730. System 740 is also coupled to annotation playback device 750. Preferably, system 1073 is a personal computer, PDA or the like.

Image data storage system 720 is a conventional storage device for storing image data and may comprise any of the structures previously described in connection with storage 50. Similarly, annotation data storage system 740 is a conventional system for storing annotation information and may comprise any of the structures previously described in connection with storage 50.

Network device 710 routes image data to image data storage system 720 and annotation information to annotation data storage system 740. Preferably, network device 710 includes identifying information with the image data and annotation information, respectively, to facilitate the coordinated retrieval of annotation information stored in system 740 with image data stored in system 720. As required by a user, image data storage system 720 supplies image data to image display 730 and annotation data storage system 740 supplies annotation information to playback device 750.

FIG. 7D illustrates image and annotation playback system 1074. System 1074 comprises image receiver and display 760, communications device 770, and data storage system 780. As shown, each of image receiver and display 760, device 770 and system 780 are coupled to communications network 540. Image receiver and display 760 is the same as image receiver and display 640. Communications device 770 is a conventional communications device as described hereinabove, e.g., the same as telephone 210, personal communications device 250 or the like. Data storage system 780 comprises either image data storage system 720 or annotation data storage system 740, or both.

In operation, image data and annotation information received by communications network 540 are stored in data storage system 780. An indication that such storage has occurred is provided to a user via communications device 770. Upon command by a user, image receiver and display 760 retrieves image data from storage system 780 and communications device 770 retrieves annotation information from storage system 780. In an alternate embodiment, image data is directly received at image receiver and display 760 and annotation information is stored in data storage system 780. Preferably, image receiver and display 760 is a facsimile machine, device 770 is a telephone and system 780 is a remote voice messaging system.

FIG. 7E illustrates image and annotation playback system 1075. System 1075 comprises annotation receiver and processor 810, image display 820, annotation playback device 830, communications device 840, data storage system 850, network device 860, image display 870 and annotation playback device 880. As shown, annotation receiver and processor 810, device 840, system 850, and device 860 are coupled to communications network 540. Device 820 and display 830 are coupled to annotation receiver and processor 810. Playback device 870 and display 880 are coupled to network device 860.

Annotation receiver and processor 810 is a device for receiving annotation information and processing same. Image display 820 is the same as image display 620. Annotation playback device 830 is the same as annotation playback device 630. Communications device 840 is the same as communications device 770. Storage system 850 is the same as storage system 780. Network device 860 is the same as network device 610. Image display 870 is the same as image display 620 and annotation playback device 880 is the same as annotation playback device 630.

In a preferred operation, image data is received by network device 860 and routed for display at image display 870 and a corresponding annotation is received at annotation receiver and processor 810. Processor 810 examines the annotation to identify the recipient and retrieves from storage, preferably data storage system 850, annotation reproduction preferences corresponding to the recipient. In accordance with the retrieved preferences, processor 810 routes the annotation for display by playback device 830, communications device 840, storage system 850, or playback device 880 (via network device 860). Also in accordance with the retrieved preferences, processor 810 generates an indication of annotation and routes it to one or more of the other devices of system 1075 to notify the recipient of the existence of an annotation.

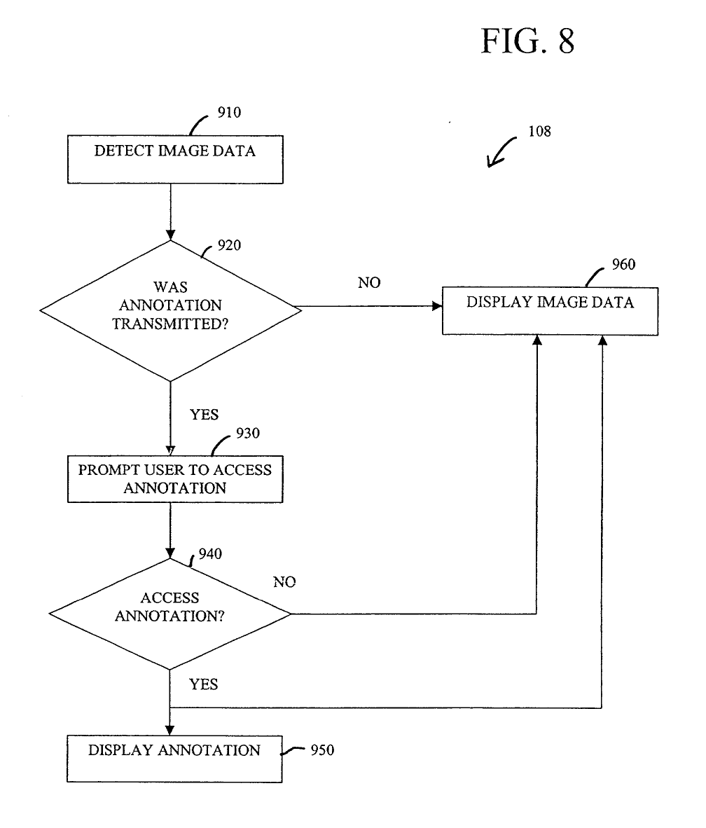

FIG. 8 illustrates a process 108 according to another embodiment of the present invention. Preferably, process 108 is a method of operation of image and annotation playback system 550. Process 108 begins with step 910, in which image data is received from a communications network and recognized as image data. Processing proceeds with step 920. In step 920, a determination is made as to whether or not annotation information was transmitted corresponding to the image data already received. If annotation information was transmitted, processing proceeds with step 930; otherwise, processing proceeds with step 960.

In step 930, the user is notified that image data, annotation information, or both, are available for access. Processing proceeds with step 940. According to step 940, the user is polled to determine whether or not access to the annotation information is desired. If the user indicates that the annotation information is to be accessed, then processing proceeds with steps 950 and 960; otherwise, processing proceeds with step 960.

In step 950, the annotation information is reproduced for, e.g., displayed to, the user. In step 960, the image data is displayed to the user.

In an alternative process 108, steps 930 and 940 are omitted so that the annotation information is reproduced according to step 950 when the user accesses the corresponding image data. Preferably, when the image data is displayed, the annotation information is reproduced automatically and is synchronized with the image data display.

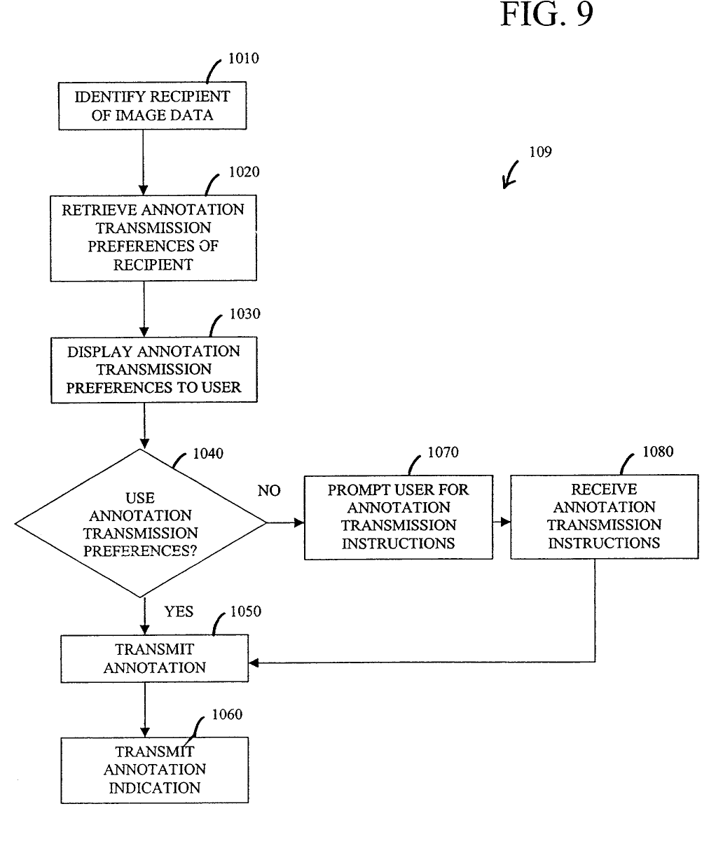

FIG. 9 illustrates a process 109 according to another embodiment of the invention. Preferably, process 109 is implemented in image and annotation processing system 530. Process 109 commences with step 1010, in which image data is received, along with an indication of the intended recipient of the image data. Processing proceeds with step 1020. In step 1020, the pre-stored annotation transmission preferences of the identified recipient are retrieved. Processing proceeds with step 1030.

According to step 1030, the retrieved annotation transmission preferences corresponding to the recipient are displayed to the user. Processing proceeds with step 1040. In step 1040, the user is polled to determine whether or not the annotation transmission preferences should be utilized for the transmission of annotation information to the identified recipient. If the user indicates that the transmission preferences are to utilized, then processing proceeds with step 1050; otherwise, processing proceeds with step 1070.

In step 1050, the annotation information corresponding to the image data is transmitted to the recipient according to the annotation transmission preferences. Preferably, processing proceeds with step 1060 but optionally, step 1060 may be omitted. In step 1060, a separate indication of the existence of annotation information is transmitted to the recipient in accordance with the annotation transmission preferences. Transmission of the annotation indication may occur by a different method or mode of communication than the transmission of the annotation itself.

In step 1070, the user is prompted to supply particular annotation transmission instructions for transmission of the annotation information. Processing proceeds with step 1080. In step 1080, annotation transmission instructions are received from the user and processing proceeds with step 1050, where the annotation transmission instructions are used in lieu of annotation transmission preferences.

While preferred embodiments of the invention have been described with particularity and with reference to the drawings, modifications and variations of the foregoing will be apparent to those of skill in the art utilizing the techniques disclosed herein. It is, therefore, to be understood that such embodiments are illustrative and not limiting on the scope of the present invention and that the invention encompasses such modifications and variations.

What is claimed is:

1. An annotation processing apparatus comprising:
an image data interface;
an annotation interface; and
a processor, coupled to said image data interface and said annotation interface;
wherein said processor detects a transmission of image data presented at said image data interface and controls said annotation interface to prompt a user to supply an annotation.

2. The apparatus according to claim 1 further comprising a data storage coupled to said processor; and
wherein said processor controls said data storage to store said annotation received via said annotation interface.

3. The apparatus according to claim 2 further comprising a communications interface coupled to said processor; and
wherein said processor retrieves said annotation from said storage and transmits said annotation to a recipient via said communications interface.

4. The apparatus according to claim 3 wherein said processor controls said image data interface to emulate one of a network, a network device and a computer.

5. The apparatus according to claim 3 wherein said processor controls said data storage to store an image data received via said image data interface; and
wherein said processor retrieves said image data from said storage and transmits said image data to said recipient via said communications interface.

6. The apparatus according to claim 3 wherein said processor creates a modified image data by modifying an image data received via said image data interface; and
wherein said processor causes said modified image data to be transmitted to said recipient via said communications interface.

7. The apparatus according to claim 6 wherein said modified image data includes an indication of separate annotation.

8. The apparatus according to claim 6 wherein said modified image data and said image data are formatted according to different protocols.

9. The apparatus according to claim 1 further comprising a user interface coupled to said processor; and
wherein said processor receives via said user interface a user command to control an operation of the apparatus.

10. The apparatus according to claim 1 wherein said annotation interface comprises a telephone handset.

11. A method of annotating an image data comprising the steps of:
receiving a transmission of said image data to a recipient;
receiving from an annotation source an annotation corresponding to the image data; and
transmitting said annotation to the recipient.

12. The method according to claim 11 further comprising the step of transmitting said image data to the recipient for the image data.

13. The method according to claim 11 further comprising the step of retrieving from storage a transmission preference corresponding to the recipient; and wherein said step of transmitting comprises the step of transmitting said annotation to the recipient in accordance with said transmission preference.

14. The method according to claim 13 wherein said transmission of said image data to the recipient is by a first communications protocol;
wherein the transmission of said annotation to the recipient is by a second communications protocol; and
wherein said first communications protocol is different from said second communications protocol.

15. The method according to claim 13 wherein said transmission of said image data to the recipient is by a first communications system;
wherein the transmission of said annotation to the recipient is by a second communications system; and
wherein said first communications system is different from said second communications system.

16. The method according to claim 11 further comprising the steps of:
retrieving from storage a transmission preference corresponding to the recipient;
displaying said transmission preference to a user; and
receiving from the user a transmission instruction; and
wherein said step of transmitting comprises the step of transmitting said annotation to the recipient in accordance with said transmission instruction.

17. The method according to claim 11 wherein said annotation source is a user-controlled audio input device.

18. The method according to claim 11 wherein said annotation source is a user-controlled video input device.

19. The method according to claim 11 further comprising the step of transmitting an indication of annotation to the recipient.

20. The method according to claim 11 further comprising the step of modifying said image data to include an indication of annotation.

21. A method of annotating an image data comprising the steps of:
receiving a transmission of said image data to a recipient;
receiving from an annotation source an annotation corresponding to the image data;
displaying said annotation to a user;
receiving from the user a second annotation; and
transmitting said second annotation to the recipient for the image data.

22. A method of annotating an image data comprising the steps of:
receiving a transmission of said image data to a recipient;
displaying said image data to a user;
receiving a selection of a portion of said image data from the user;
receiving from an annotation source an annotation corresponding to said portion; and
transmitting said annotation to the recipient.

23. The method according to claim 22 further comprising the steps of generating an address corresponding to said portion; and
transmitting said address to the recipient.

24. An image data and annotation communication system comprising:
an image and annotation processing system; and
a communications network coupled to said image and annotation processing system.

25. A system according to claim 24 further comprising a source of image data coupled to said image and annotation processing system.

26. A system according to claim 24 further comprising an annotation source coupled to said image and annotation processing system.

27. A system according to claim 24 further comprising an annotation playback system coupled to said communications network.

28. A system according to claim 24 wherein said communications network comprising communications systems utilizing at least one of a satellite communications system, a local area network, a wide area network, the Internet, a public telephone system, an optical communications system, and a wireless communications system.

29. A system according to claim 24 wherein said image and annotation processing system comprises:
an annotation transmission device operable to transmit an annotation through said communications network by a first protocol different than a second protocol by which an image data is transmitted through said communications network.

30. A system according to claim 24 wherein said image and annotation playback system comprises:
a facsimile machine having a handset; and
a voice messaging system.
